(19) United States
(12) Patent Application Publication
(10) Pub. No.: US 2020/0302442 A1
(43) Pub. Date: Sep. 24, 2020

(54) SYSTEMS AND METHODS FOR TOKENIZING TOKENS IN TRANSACTIONS

(71) Applicant: MasterCard International Incorporated, Purchase, NY (US)

(72) Inventor: Adam Kenneth Hosp, Lake St. Louis, MO (US)

(21) Appl. No.: 16/723,359

(22) Filed: Dec. 20, 2019

Related U.S. Application Data
(63) Continuation-in-part of application No. 15/826,137, filed on Nov. 29, 2017, now abandoned.
(60) Provisional application No. 62/504,219, filed on May 10, 2017.

(51) Int. Cl. G06Q 20/38; G06Q 20/40; H04L 9/32

(52) U.S. Cl. CPC G06Q 20/38215; G06Q 20/401; G06Q 2220/00; H04L 2209/56; H04L 9/3213

(57) ABSTRACT

Systems, methods and computer program code are provided for receiving a token and a request to generate a sub-token based on the token, identifying an association between the token and a primary account number (PAN) of a user, generating a sub-token associated with the token and the PAN, and providing the sub-token for use in a payment transaction.

### RELATED APPLICATIONS

This application is a continuation-in-part and claims benefit of and priority to U.S. patent application Ser. No. 15/826,137 filed on Nov. 29, 2017.

### BACKGROUND

In November 2013, MasterCard International Incorporated (the assignee hereof), Visa and American Express jointly published guidelines entitled “Payment Token Interoperability Standard” (hereinafter referred to as the “Tokenization Standard”). The Tokenization Standard referred to a concept called “tokenization,” in which surrogate values (“tokens”) replace primary account numbers (PANs) of payment cards (such as credit or debit cards) during part of the operation of payment systems. One reason for using tokens in place of PANs is to combat potentially fraudulent activities.

In a typical tokenization transaction, the PAN associated with a consumer's payment card is converted into a token by a token service provider (e.g., the PAN is “tokenized”). Then, the consumer can cause the token to conduct transactions rather than using the PAN.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a system pursuant to some embodiments.

FIG. 2 illustrates a mapping of tokens and sub-tokens to PANs that may occur in the system of FIG. 1 pursuant to some embodiments.

FIG. 3 is a portion of a platform that may be used in the system of FIG. 1 pursuant to some embodiments.

FIG. 4 is a tabular portion of a user database according to some embodiments.

FIG. 5 is a flow diagram that illustrates a process that may be performed pursuant to some embodiments.

FIG. 6 is a user interface that illustrates a user interaction pursuant to some embodiments.

### DETAILED DESCRIPTION

In general, and for the purpose of introducing concepts of the present disclosure, merchants, social networks, and other platforms may operate to generate tokens associated with tokenized payment credentials. For example, pursuant to some embodiments, a consumer may interact with a platform to provide a payment credential to the platform. The platform is operated to obtain a first tokenized representation of the payment credential. Then, for each transaction (or for groups of transactions), the platform is operated to obtain one or more further tokenized representations of the first tokenized representation of the payment credential. As will be described further herein, the use of such further tokenized representations provide a number of benefits to the consumer and to the platform.

For convenience and ease of exposition, the following terms will be used. The term “PAN” or “payment credential” will be generally used to refer to a payment account number or identifier issued by a financial institution to a user (such as a “consumer”). The term “consumer” is used herein to refer to a holder of a PAN or payment credential, and may refer to an individual or an entity such as a business. The term “primary token” refers to a payment token that is associated with a PAN or payment credential and that can directly be used by a token service provider or other entity or service provider to identify the PAN or payment credential. The term “sub-token” or “secondary token” refers to a token associated with a primary token (where the sub-token is generated from the primary token). The term “tertiary token” refers to a token associated with a sub-token or secondary token (or another tertiary token). Each of the primary token, and any sub-tokens or tertiary tokens may be referred to simply as a “token” or “payment token”. Each token may be generated using a tokenization service such as the MasterCard Digital Enablement Service (“MDES”) or the like. Each token associated with a PAN may be used to conduct financial transactions associated with the payment account associated with the PAN.

Pursuant to some embodiments, a sub-token (or tertiary token) may be created with one or more authorization parameter(s). For example, a sub-token may be generated with an authorization parameter allowing the sub-token to be used in a specific transaction or type of transaction. As a specific illustrative, but not limiting example, the sub-token may be generated for use in a transaction at a specific merchant and/or with a specific dollar amount (e.g., the transaction may only be authorized if the sub-token is used at a Target® store for a transaction under $100).

Pursuant to some embodiments, the consumer may be associated with an account associated with the platform. As an illustrative, but not limiting example, a consumer may have an account on a social network platform. The account may uniquely identify the consumer to the social network platform. In some embodiments, the consumer may establish a primary token associated with a PAN or payment credential for use in transactions facilitated by or through the platform. Further, pursuant to some embodiments, the consumer may interact with the platform to establish one or more sub-tokens (and/or tertiary tokens) of the payment credential for use with specific transactions or groups of transactions. As an illustrative, but not limiting example, a consumer may establish a sub-token of a payment credential for use in a specific transaction that the consumer wishes to track or control separately. These and further embodiments will be described further herein.

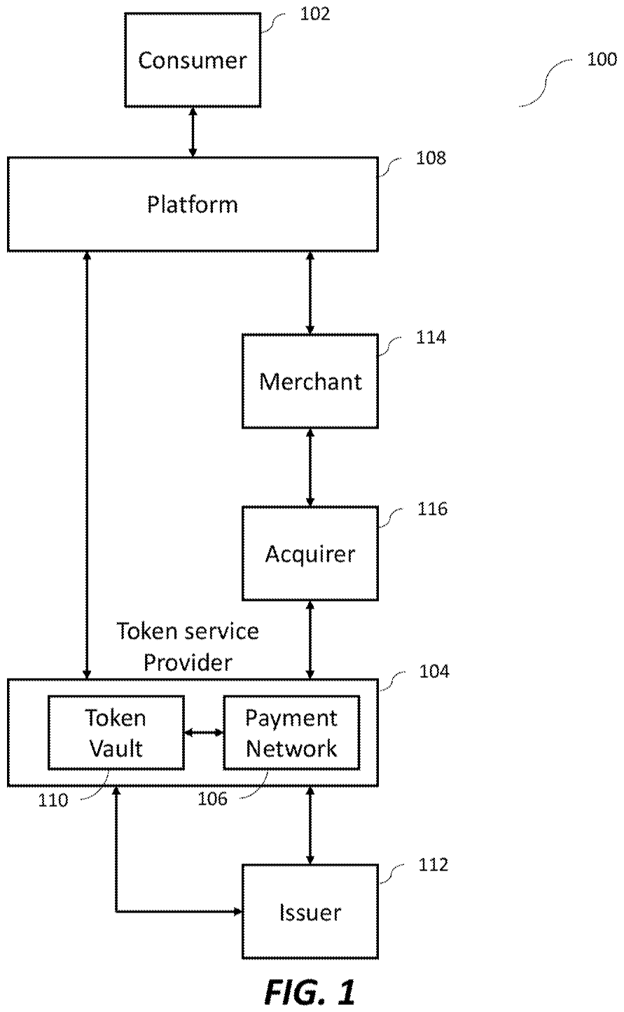

FIG. 1 is a block diagram that illustrates a payment system 100 in which teachings of the present disclosure may be applied. Individual users or payment card holders (generally, referred to herein as “consumers”) are indicated by reference numeral 102 in FIG. 1. As shown, consumers 102 interact with a platform 108. Platform 108 may be, for example, a platform operated by or on behalf of a social network (such as Facebook® or the like) or a platform operated by or on behalf of a network of merchants or other entities which allow consumers 102 to create accounts and purchase goods or services as will be described further herein.

FIG. 1 also includes a block 104 that represents a token service provider. The token service provider 104 may in some embodiments also be the operator of a payment network (block 106), such as that operated by MasterCard International Incorporated, the assignee hereof The token service provider 104 may be authorized in the system 100 to issue tokens to token requestors (one such token requestor may be, for example, the platform 108). In issuing tokens, the token service provider 104 may perform such functions as operating and maintaining a token vault 110, generating and issuing tokens (in accordance, e.g., with aspects of the present disclosure), assuring security and proper controls, token provisioning (e.g., personalizing payment cards, etc. with token values), and registering token requestors. Pursuant to some embodiments, the token service provider 104 is further operable to generate sub-tokens and tertiary tokens from primary tokens.

In addition to representing the token service provider, block 104 should also be understood to represent one or more computer systems operated by the token service provider. In some embodiments, the token service provider 104 may further be configured to implement functionality of the MasterCard Digital Enablement Service (“MDES”), a service of MasterCard International Incorporated, the assignee hereof. Those skilled in the art will appreciate that the token service provider 104 may be configured to operate to tokenize payment card information according to other standards or using other infrastructure, so long as the tokens are usable in payment transactions as described herein.

Block 112 in FIG. 1 represents an issuer of payment card accounts held by the consumer 102. In some embodiments, some or all of the functions of the token service provider 104 may be taken on by the issuer 112. The issuer 112 may include a number of systems and components operated by or on behalf of a financial institution that issues payment card accounts to individual consumers 102. The issuer 112 may perform such functions as (a) receiving and responding to requests for authorization of payment card account transactions to be charged to payment accounts issued by the financial institution and (b) tracking and storing transactions and maintaining account records.

Block 114 in FIG. 1 represents a merchant that a consumer 102 may transact with. As shown, consumer 102 transacts with the merchant 114 via the platform 108. As an illustrative, but not limiting example, the merchant 114 may be a merchant that provides video on demand (such as Netflix® or Amazon®, etc.), and a consumer 102 may wish to rent or purchase a video from the merchant 114. In some embodiments, the consumer 102 may obtain a payment token by interacting with the platform 108 and cause the platform 108 to present the payment token to the merchant 114 for the goods or services. Pursuant to some embodiments, the payment token may be generated by or on behalf of the platform 108 from another token previously created for the consumer 102. The merchant 114, upon receipt of the payment token, uses the payment token to initiate processing of a payment transaction using the payment token. For example, the merchant 114 may cause a payment authorization request to be processed through an acquirer 116. As is well known, the acquirer 116 may be a financial institution that provides banking services to the merchant 114, and that receives and routes authorization requests originated from the merchant 114. The payment authorization request is routed from the acquirer 116 through a payment network 106 to an issuer 112 of the payment account associated with the payment token.

One well known example of a payment network 106 is referred to as the “Banknet” system, and is operated by MasterCard International Incorporated, which is the assignee hereof.

While only individual blocks are shown in FIG. 1 for simplicity, those skilled in the art will appreciate that a practical embodiment of the system 100 may include numerous consumers 102, platforms 108, merchants 114, acquirers 116, and issuers 112. Further, multiple token service providers 104, payment networks 106 and token vaults 110 may also be provided.

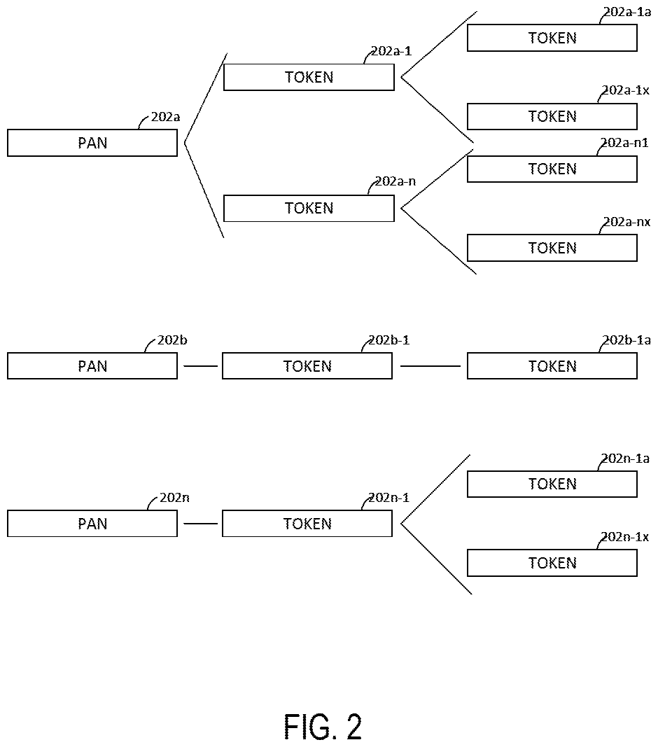

As discussed above, multiple levels or layers of tokens may be used pursuant to some embodiments of the present invention. To further illustrate features of some embodiments, reference is now made to FIG. 2, where a variety of PAN and token mapping relationships are shown. These relationships may be maintained and managed, for example, by a token service provider 104 based on requests received from entities such as the platform 108. Each of the tokens and their relationships to a PAN may be stored in a secure database such as, for example, a token vault 110 associated with the token service provider 104.

Each PAN 202a-n may, for example, be associated with one or more primary tokens 202a-1, etc. Each PAN 202a-n may also, for example, be associated with one or more sub-tokens 202a-1a, etc. Those skilled in the art, upon reading this disclosure, will appreciate that additional layers of tokens may also be provided (e.g., such as tertiary or other tokens). As shown, a number of primary tokens 202a-1 to 202a-n are mapped to PAN 202a. A number of sub-tokens 202a-1a to 202a-nx are also mapped to PAN 202a. Each of the tokens shown as having a relationship with a PAN are usable to conduct transactions involving that PAN through operation of the system 100.

In some situations, a PAN (such as PAN 202b) is associated with a single primary token (such as token 202b-1) and a single sub-token (such as token 202b-1a). In some situations, a PAN (such as PAN 202n) is associated with a single primary token (such as token 202n-1) and multiple sub-tokens (such as token 202n-1a-202n-1x). A wide variety of different combinations and permutations may be provided. Although only three PANs are explicitly shown in token vault 110 in FIG. 2, in practice, the number of PANs stored therein, with tokens mapped thereto, may be quite a large number.

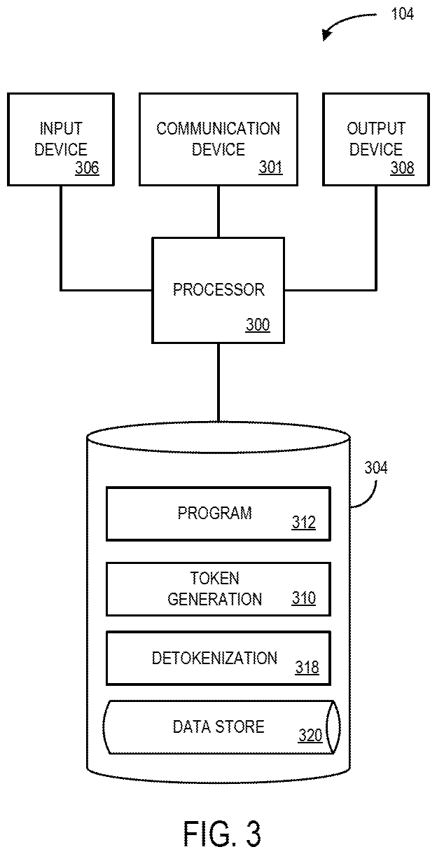

FIG. 3 is a block diagram representation of a computer system that may be operated by the token service provider in accordance with aspects of the present disclosure. This computer system, indicated by reference numeral 104, may be referred to as the “token service provider computer 104” and may perform at least some functions in accordance with aspects of the present disclosure. For example, the token service provider computer 104 may be configured to receive requests from a token requestor, such as platform 108, to generate primary tokens, sub-tokens and tertiary tokens that correspond to PANs of consumers that interact with the platform 108.

The token service provider computer 104 may be conventional in its hardware aspects but may be controlled by software to cause it to function as described herein. For example, the token service provider computer 104 may be constituted by conventional server computer hardware. In some embodiments, functionality disclosed herein may be distributed among two or more computers having hardware architecture similar to that described below.

The token service provider computer 104 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the token service provider computer 104 to provide desired functionality.

Communication device 301 may be used to facilitate communication with, for example, other devices (such as other components of the system 100 shown in FIG. 1). For example (and continuing to refer to FIG. 3), communication device 301 may comprise numerous communication ports (not separately shown), to allow the token service provider computer 104 to communicate simultaneously with a number of other computers and other devices, including communication with the platform 108.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the token service provider computer 104, executed by the processor 300 to cause the token service provider computer 104 to function as described herein.

The programs may include one or more conventional operating systems (not shown) that control the processor 300 so as to manage and coordinate activities and sharing of resources in the token service provider computer 104, and to serve as a host for application programs (described below) that run on the token service provider computer 104.

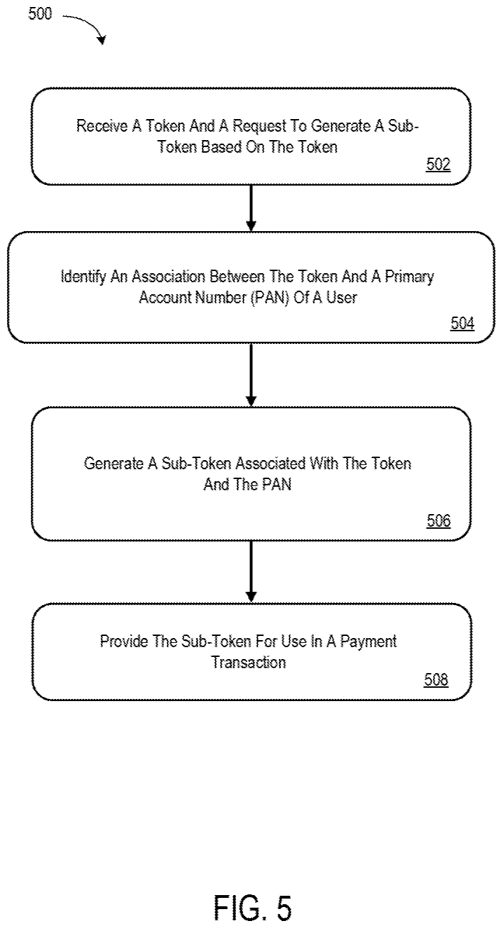

The programs stored in the storage device 304 may also include a token generation program 310 that controls the processor 300 to enable the token service provider computer 104 to generate tokens based on token creation requests received from devices such as the platform 108. Details of some of the functionality provided by the token generation program 310 will be discussed below in conjunction with FIG. 5.

Another program that may be stored in the storage device 304 is an application program or program module 312 that controls the processor 300 to enable the token service provider computer 104 to generate a mapping of tokens relative to the PANs that they represent. This program 312 will hereafter be referred to as the token map generation application program; functionality thereof will be described below in conjunction with FIG. 5.

Moreover, the storage device 304 may further store a program/program module 318 that enables the token service provider computer 104 to perform de-tokenization with respect to tokens that it receives for that purpose. The de-tokenization enabled by program/program module 318 may in general be consistent with the proposals contained in the above-referenced Tokenization Standard. As is known to those who are skilled in the art, “de-tokenization” refers to substituting a PAN for a token that represented the PAN. Embodiments described herein further allow the substitution of a PAN for a sub-token, a tertiary token or a primary token that represented the PAN.

The storage device 304 may also store, and the token service provider computer 104 may also execute, other programs, which are not shown. For example, such programs may include a reporting application, which may respond to requests from system administrators for reports on the activities performed by the token service provider computer 104. The other programs may also include, e.g., communication software, database management software, device drivers, etc.

The storage device 304 may also store one or more databases 320 required for operation of the token service provider computer 104. Those databases 320 may, for example, include the token vault 110 shown in FIG. 1.

In some embodiments, at least some of the functionality ascribed below to the token service provider computer 104 may alternatively be performed by another computer or computers in the system 100 of FIG. 1 (e.g., by a computer or computers operated by the issuer 112 or by the acquirer 116). Such computer or computers may have essentially the same hardware architecture as the token service provider computer 104, and like the token service provider computer 104, may be programmed by suitable software program instructions to provide functionality as described herein.

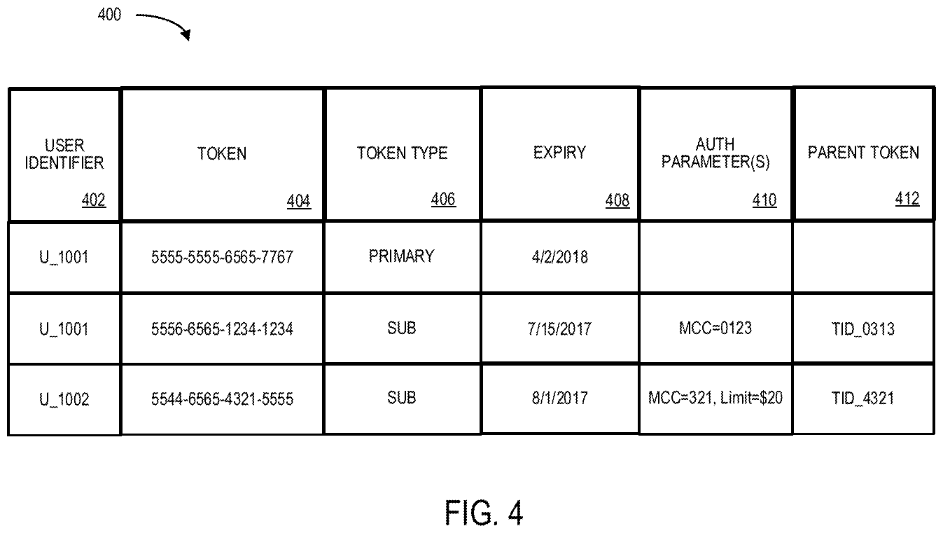

FIG. 4 is a tabular representation of a portion of a token data table 400 in accordance with some embodiments of the present invention. The table 400 includes entries associated with different users of a platform 108 and different tokens and token authorization parameters. The table 400 also defines fields for each of the entries. The fields might specify a user identifier 402 (associated with a user identifier provided by a system such as platform 108 to uniquely identify users of the platform 108), a token 404 (associated with a primary token, a sub-token or a tertiary token), and a token type 406 (specifying whether the token is a primary token, a sub-token or a tertiary token), an expiry date 408 of the token. Pursuant to some embodiments, additional information may also be provided in the form of one or more authorization parameter(s) 410 that have been provided by a system such as platform 108. The authorization parameter(s) may be used to control how and where the token 404 may be used, and may include authorization controls such as a limitation to a specific merchant category code (“MCC”) or group of categories, authorization limits (such as a spend limit), or the like. In some embodiments, each token 404 may also be associated with information identifying the parent token 412 which the token 404 is related to. The information in the database 400 may be periodically created and updated based on information received from, for example, platform 108 or other components of system 100.

FIG. 5 is a flow chart that illustrates a process 500 that may be performed in accordance with aspects of the present disclosure. The process steps illustrated in FIG. 5 may be performed by the token service provider computer 104 and/or by a computer or computers operated by the issuer 112 (FIG. 1). In some embodiments, the process 500 is performed by the token service provider computer 104 in response to messages, requests or instructions received from platform 108. For example, a user (such as a consumer 102) may interact with platform 108, and that interaction may cause the platform 108 to submit requests to the token service provider computer 104 to perform the process 500 (e.g., to create a sub-token from a primary token associated with the consumer's account with the provider 108 in order to use the sub-token for one or more transactions).

Process 500 may begin at 502 where a token is received (which may be, for example, a “primary token” associated with a user's account at platform 108) as well as a request to generate a sub-token based on the token. For example, the request may be received pursuant to an application programming interface (API) of the token service provider computer 104 (e.g., such as an API method to generate a sub-token). Processing continues at 504 where an association between the token and a primary account number (PAN) of a user is identified. For example, processing at 504 may include operating the token service provider computer 104 to confirm the validity of the token and to look up or otherwise confirm its association with a PAN.

Processing continues at 506 where a sub-token associated with the token and the PAN is generated. The sub-token may be generated using, for example, a tokenization process such as the MDES process or the like. Once the sub-token is generated, the association between the generated sub-token, the primary token, and the PAN is recorded for further reference. The token service provider computer 104 may store sub-tokens generated at 506 in a manner such as to indicate a mapping of sub-tokens to the PANs that they represent. The mapping of tokens to PANS may be stored in a suitable database, such as the above-mentioned token vault 110.

The generated sub-token is then provided for use in a payment transaction at 508. For example, processing at 508 may include the token service provider computer 104 transmitting the sub-token to the platform 108. For example, the sub-token may be returned in a response message to the API request described above. The platform 108 may then operate to store the sub-token in the consumer's user account with the platform 108.

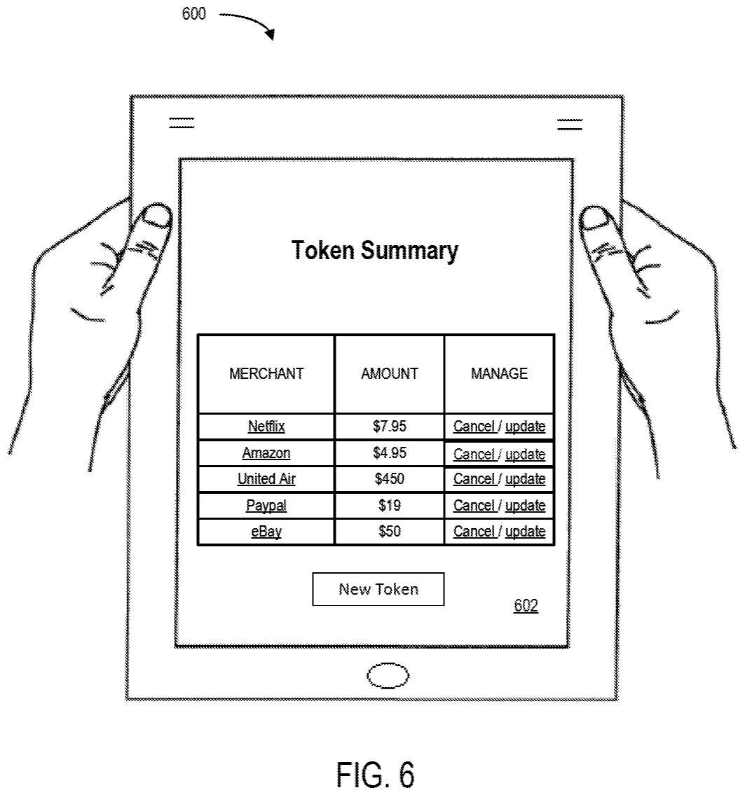

Pursuant to some embodiments, platform 108 may include features and user interfaces that allow users of the platform (such as customers 102) to manage their tokens. For example, referring to FIG. 6 (where an illustrative user interface 602 is shown that may be displayed on a display device of a device operated by customer 102), platform 108 may allow a user to view tokens and transactions associated therewith. In the illustrative user interface 602, a user has had separate tokens (or sub-tokens) issued for use with specific merchants or retailers. The user may be permitted to cancel or update the details of each or all of the tokens to manage their use. For example, in some embodiments, the user may connect merchant accounts with the user's account on the platform 108. As a specific illustrative example, the user may connect their Netflix® account with the platform such that a token issued or obtained by the platform 108 (e.g., using the process 500 discussed above) is automatically provided to or associated with the user's Netflix® account. In some embodiments, rather than automatically providing the token to the user's external account, the user may be provided with instructions for entering the token in the external account. In the illustrative user interface 600, the user may click on a name of a merchant to be taken to the user's account with the merchant so the user can administer or manage that account. As shown in the illustrative user interface 600, a user may also be provided with an option to request a “new token” (e.g., using the process 500 discussed above). Other user interfaces may also be provided to allow users to manage the issuance and use of tokens and sub-tokens. While some embodiments have been described for use with a platform 108, those skilled in the art, upon reading this disclosure, will appreciate that the generation and use of sub-tokens as described herein may be used without a platform 108. For example, sub-tokens may be generated and managed by payment system wallets, issuer wallets, or the like.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

The term “payment card network” or “payment network” is used to refer to a payment network or payment system such as the systems operated by MasterCard International Incorporated (which is the assignee hereof), or other networks that process payment transactions on behalf of a number of merchants, issuers and cardholders.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a token and a request to generate a sub-token based on the token;
identifying an association between the token and a primary account number (PAN) of a user;
generating a sub-token associated with the token and the PAN; and
providing the sub-token for use in a payment transaction.

2. The method of claim 1, further comprising:
receiving the sub-token and a request to generate a tertiary token based on the sub-token;
identifying an association between the sub-token and the PAN of a user;
generating a tertiary token associated with the sub-token, the token, and the PAN; and
providing the tertiary token for use in a payment transaction.

3. The method of claim 1, further comprising:
receiving an authorization request for a payment transaction, the request including a sub-token as the payment identifier;
identifying the PAN associated with the sub-token; and
completing the authorization using the PAN as the payment identifier.

4. The method of claim 1, wherein the receiving the request to generate the sub-token further includes a request to establish at least a first authorization parameter for the sub-token.

5. The method of claim 4, wherein the at least a first authorization parameter is at least one of a merchant category restriction, a transaction limit restriction and a time restriction.

6. A method, comprising:
identifying a user and a user account of a platform;
receiving a request to register a payment account for use in transactions initiated through the platform, the payment account identified by a primary account number (PAN);
obtaining a primary token by establishing an association between the primary token and the PAN;
storing the primary token in association with the user account;
generating a sub-token associated with the primary token and the PAN; and
providing the sub-token for use in a payment transaction.

7. The method of claim 6, further comprising:
providing the sub-token to a merchant for use in conducting the payment transaction with the merchant.

8. The method of claim 7, wherein the providing the sub-token to the merchant comprises:
identifying an account of the user at the merchant;
storing the sub-token in association with the account at the merchant for use in conducting payment transactions with the merchant.

9. The method of claim 6, further comprising:
generating a plurality of sub-tokens associated with the primary token and the PAN; and
providing the plurality of sub-tokens for use in payment transactions.

10. A system, comprising:
a communication device to receive a request to generate a token and to transmit a response;
a processor coupled to the communication device; and
a computer storage device in communication with the processor and storing instructions adapted to be executed by the processor to:
receive a token and a request to generate a sub-token based on the token;
identify an association between the token and a primary account number (PAN) of a user;
generate a sub-token associated with the token and the PAN; and
provide the sub-token for use in a payment transaction.

11. The system of claim 10, wherein the computer storage device further stores instructions adapted to be executed by the processor to:
receive the sub-token and a request to generate a tertiary token based on the sub-token;
identify an association between the sub-token and the PAN of a user;
generate a tertiary token associated with the sub-token, the token, and the PAN; and
provide the tertiary token for use in a payment transaction.

12. The system of claim 10, wherein the computer storage device further stores instructions adapted to be executed by the processor to:
receive an authorization request for a payment transaction, the request including a sub-token as the payment identifier;
identify the PAN associated with the sub-token; and
complete the authorization using the PAN as the payment identifier.

13. The system of claim 10, wherein the receiving the request to generate the sub-token further includes a request to establish at least a first authorization parameter for the sub-token.

14. The system of claim 13, wherein the at least a first authorization parameter is at least one of a merchant category restriction, a transaction limit restriction and a time restriction.
